(19) United States
(12) Patent Application Publication
(10) Pub. No.: US 2026/0154457 A1
(43) Pub. Date: Jun. 4, 2026

(54) AUTOMATED CHARACTERISTIC DETECTION SYSTEM OF A COMPUTER NETWORK COMPRISING ELECTRONIC DEVICES

(71) Applicant: Express Scripts Strategic Development, Inc., St. Louis, MO (US)

(72) Inventors: Jonathan E. Magen, Jenkintown, PA (US); Brittany P. DePoi, South Windsor, CT (US)

(21) Appl. No.: 18/965,436

(22) Filed: Dec. 2, 2024

(51) Int. Cl. G06F 21/64

(52) U.S. Cl. CPC G06F 21/64

(57) ABSTRACT

Apparatuses, systems, and methods relate to identifying that an electronic device is associated with a chain of proof that includes a first entry, where the first entry is associated with a first compliance result of a first compliance test that is executed on the electronic device. The first compliance result is in a structured data format. The apparatuses, systems, and methods further identify a trigger to execute a second compliance test for the electronic device, identify a second compliance result of the second compliance test, wherein the second compliance result is in the structured data format, and record the second compliance result into a second entry of the chain of proof.

### TECHNICAL FIELD

The present disclosure relates to an enhanced system to record compliance characteristics of a computing system. Further, examples relate to an automated system that executes in real time to determine when compliance characteristics of a computing system can be gathered, records the compliance characteristics and determines when the computing system is non-compliant.

### BACKGROUND

Computing systems have become increasingly complex and sophisticated. Correspondingly, the workloads, reliance and trust in computing systems has increased. For example, computing systems can store and operate on different types of sensitive data and support numerous distinct technologies.

### BRIEF DESCRIPTION OF THE SEVERAL VIEWS OF THE DRAWINGS

The various advantages of the examples of the present disclosure will become apparent to one skilled in the art by reading the following specification and appended claims, and by referencing the following drawings, in which:

FIG. 1 is a diagram of an example of a granular compliance detection process according to an example;

FIG. 2 is a diagram of an example of a non-compliance process according to an example;

FIG. 3 is a diagram of an example of a process to remedy non-compliance according to an example;

FIG. 4 is a diagram of an example of a compliance and audit bundle data model according to an example;

FIG. 5 is a diagram of an example of a proof-of-work and user-interface tree of compliance according to an example;

FIG. 6 illustrates a block diagram of an example of a computing system according to an example;

FIG. 7 is a flowchart of an example of compliance detection according to an example;

FIG. 8 is a block diagram of an example patient management platform that may be deployed within the system of FIG. 1, according to some examples; and

FIG. 9 is a functional block diagram of an example neural network that can be used for the inference engine or other functions (e.g., engines) as described herein to produce a predictive model.

### DETAILED DESCRIPTION

Protecting computing systems from malicious attacks (e.g., malware attacks) has become increasingly difficult as the level of sophistication, coordination and determination of the attacks has increased. For example, as industries, companies and individuals have become increasingly reliant on computing systems, sensitive data has become ubiquitously stored and used in different computing systems. Sensitive data can include confidential information that organizations or individuals intend to keep out of the public's hands. Data can be considered sensitive if releasing the data could lead to serious consequences, such as identity theft, financial loss, embarrassment, loss of privacy or legal penalties. Access to sensitive data can be limited to only certain personnel within an organization(s) to prevent data leaks, data breaches, identity theft, financial loss, legal issues, etc. Further, access to the sensitive data can be limited to certain computing processes and programs. That is, some processes and programs can be prohibited from accessing and/or operating on the sensitive data. Thus, sensitive data can be any data that is not intended for public use and/or release (e.g., private data).

As a consequence of the above, a whole electronic and/or computer system based industry (e.g., cybersecurity) has emerged to reduce and/or prevent unauthorized data access. That is, cybersecurity is the practice of protecting networks, devices, and data from unauthorized access or criminal use. Cybersecurity involves ensuring the confidentiality, integrity, and availability of information and is the practice of being protected against the criminal or unauthorized use of electronic data, or the measures taken to achieve the above. The cybersecurity industry is estimated to be around 222.66 billion in the year 2023 and is projected to grow at a compound annual growth rate (CAGR) of 12.3% from 2023 to 2030, signifying the concern, resources and considerations surrounding data and computing infrastructure security.

Security compliance can be a measurement of cybersecurity. Security compliance is the process of following industry-specific laws, regulations, and standards related to information security. Security compliance can include the active steps an organization takes to protect the organization's assets and meet internal security and/or legal requirements. Security compliance can force organizations to take cybersecurity seriously and adopt best practices regarding systems, data, and operations of the organizations. Thus, security compliance can be a significant component of an organization's cybersecurity program.

Security compliance can also be considered to be information technology (IT) compliance. IT compliance is enforced for several reasons, particularly in present computer networks.

Firstly, IT compliance enforces data security. IT compliance seeks to ensure that sensitive data is adequately protected from unauthorized access, breaches, and cyberattacks. Compliance frameworks often include standards and protocols for data encryption, access controls, and security measures to safeguard information assets.

Secondly, IT compliance enforces regulatory requirements. Many industries are subject to regulatory mandates and standards governing data privacy, security, and confidentiality. Compliance with regulations such as GDPR (General Data Protection Regulation), HIPAA (Health Insurance Portability and Accountability Act), PCI DSS (Payment Card Industry Data Security Standard), and avoids fines, penalties, legal liabilities, and reputational damage.

Third, IT compliance enforces risk management aspects. Compliance frameworks help organizations identify, assess, and mitigate risks associated with IT operations, systems, and infrastructure. By adhering to established standards and best practices, businesses can reduce the likelihood of security incidents, data breaches, and operational disruptions that could impact financial stability and reputation.

Fourthly, IT compliance enforces customer trust and confidence. Compliance with industry regulations and security standards enhances customer trust and confidence in an organization's ability to protect sensitive information of the customers. Compliance initiatives reassure customers that data of the customers is handled responsibly and ethically, fostering stronger relationships and brand loyalty. Doing so can further provide competitive advantages.

Fifthly, IT compliance enforces business continuity. IT compliance efforts contribute to business continuity by establishing protocols and procedures for incident response, disaster recovery, and contingency planning. Compliance frameworks help organizations prepare for and mitigate the impact of disruptions caused by cyber threats, natural disasters, and other emergencies, thereby ensuring operational resilience and continuity of services.

Sixthly, IT compliance facilitates global operations and expansion. Compliance with international standards and regulations can facilitate organizations operating across multiple jurisdictions and geographic regions. Compliance initiatives facilitate expansion into new markets by ensuring alignment with diverse regulatory requirements and cultural expectations.

Therefore, IT compliance is a computer-based process for protecting data, mitigating risks, building trust with stakeholders, ensuring business continuity, and maintaining a competitive edge in today's dynamic and interconnected business environment. IT compliance provides a framework for responsible and secure IT governance, enabling organizations to navigate complex regulatory landscapes and emerging cyber threats effectively. In some instances, an auditor (e.g., a third-party, governmental auditor and/or internal party) can scrutinize compliance records to verify the security and compliance of a program. Doing so can mitigate potential future cybersecurity attacks and is used for when a control fails, and investigation subsequently occurs. Auditors however cannot manually examine an entire organization's IT structure, and are prone to error. Furthermore, auditors can have difficulty understanding the complex interrelationships between IT components as well as the underlying hardware and/or software, as well as which devices are non-compliant (e.g., not secure). Unsecured IT components can lead to longer latency operations, malicious actors gaining access to sensitive information and/or malicious actors blocking access to the unsecured IT components, etc.

Indeed, compliance is not only legally sound, but also provides several technological and computer-security enhancements. For example, malicious actors can seek to gain access to sensitive data by exploiting weaknesses in a computer infrastructure, gain control of the computer infrastructure, disrupt operations, etc. Electronic device vulnerabilities permit malicious actors to do so. As a more detailed example, unpatched software can allow an attacker to exploit publicly known vulnerabilities to gain access to sensitive data, launch a denial-of-service attack, or take control of a system. Unpatched software is one of the most found poor security practices and is non-compliant by almost every cybersecurity standard. Remedying unpatched software is a relatively rapid process, taking a few minutes to one hour. Identifying unpatched software across a distributed system and/or computer network with hundreds to thousands of nodes can be difficult, meaning that often times unpatched software is not detected and remedied in an orderly and timely fashion even though the actual patching process is relatively straightforward.

That is, identifying and updating security compliance can be difficult, particularly in a computer network. For example, some computer networks can contain hundreds and/or thousands of electronic devices (e.g., computing devices, routers, printers, network switches, and other components). Identifying compliance or non-compliance in such a large network is often an error prone process that is limited by human subjectivity, analysis and resources. Indeed, identifying whether computing systems are compliant or non-compliant is often error prone due to poor technical understanding, overwhelmingly complex systems with myriad interconnections and difficulty accessing all electronic devices. Furthermore, evidence of compliance is often distributed in a multitude of locations (e.g., log files stored on individual electronic components and/or various storage locations) leading to difficulties in identifying and retrieving such information. Indeed, in some cases the evidence is inaccessible and/or stored in an unknown location such that the evidence of compliance is lost and/or will have to be recreated. Doing so creates inefficiency (e.g., duplicative evidence analysis). Furthermore, in some cases recreating the evidence is impossible, for example, if the electronic device changes leading to difficulty identifying if the computer system was compliant in the past (e.g., at a time before the electronic device was changed). Moreover, the evidence can be in unstructured formats causing analysis to be difficult. A computer network as used herein can include electronic devices (e.g., internet-of-things devices, computers, routers, switches, servers, etc.) as well as interconnections between the electronic devices. Computer networks include business networks as well as home networks.

Such computer networks are often subject to dynamic and ongoing changes leading to confusion and difficulty identifying whether a computer network is compliant with security standards. For example, suppose that the computer network is identified as being compliant at a first time. At a second time after the first time, the computer network can be identified as non-compliant (e.g., electronic device downloaded unsecure software, new hardware component added to an electronic device). It can be difficult to ascertain when the computer network became non-compliant. That is, it can only be identified that the computer network is non-compliant at the second time, but identifying the exact moment when the computing system became non-compliant, as well as the modification and/or device that caused the non-compliance can be difficult. That is, non-compliance can only be identified as occurring at some time between the first time and the second time. As such, identifying how long non-compliance existed, how much information was compromised and whether any data theft occurred is impossible in existing systems.

Moreover, identifying non-compliance can be difficult. For example, gathering characteristics of the computer network and determining when the characteristics indicate compliance or non-compliance can be impossible for a human being to mentally execute. That is, working through copious amounts of data in different formats (some of which can be in machine code or formats and are impossible for a human being to decipher) can be impossible for a human being to execute mentally. That is, identifying compliance is a rigorous, computer-based process that cannot be mentally executed.

In some existing examples, only a subset of all electronic devices comprising a computer network are examined for compliance. That is, since examining all electronic devices is impossible, existing examples simply pick random electronic devices to examine for compliance and form mitigation strategies based on the analysis of the few random electronic devices. Doing so is however leaves significant potential security gaps and omissions since not all electronic devices are examined for compliance or verified.

Thus, existing computer networks lack the ability to identify, record and maintain records relating to compliance in a standard format. Moreover, existing computer networks lack granular compliance records. Further, existing computer network lack the functionality to identify when a computer network is non-compliant. Additionally, existing examples lack the ability to automatically execute specific actions to adjust the computer network to remedy such non-compliance. Thus, existing examples suffer from several technical problems noted above.

Examples herein remedy the above problems by identifying, recording and maintain records relating to compliance in a standard format that is accessible by computing systems and/or humans. Moreover, existing computer networks record the data in a granular manner to trace the exact moment that non-compliance occurred, as well as associated modifications that caused the non-compliance. Moreover, examples herein possess the functionality to identify when a computer network is non-compliant, and can automatically execute specific actions to adjust the computer network to remedy such non-compliance. In order to accomplish at least some of the enhancements described above, examples identify that a computing architecture is associated with a chain of proof that includes a first entry, where the first entry is associated with a first compliance result of a first compliance test that is executed on the computing architecture, where the first compliance result is in a structured data format, identify a trigger to execute a second compliance test for the computing architecture, identify a second compliance result of the second compliance test, where the second compliance result is in the structured data format, and record the second compliance result into a second entry of the chain of proof.

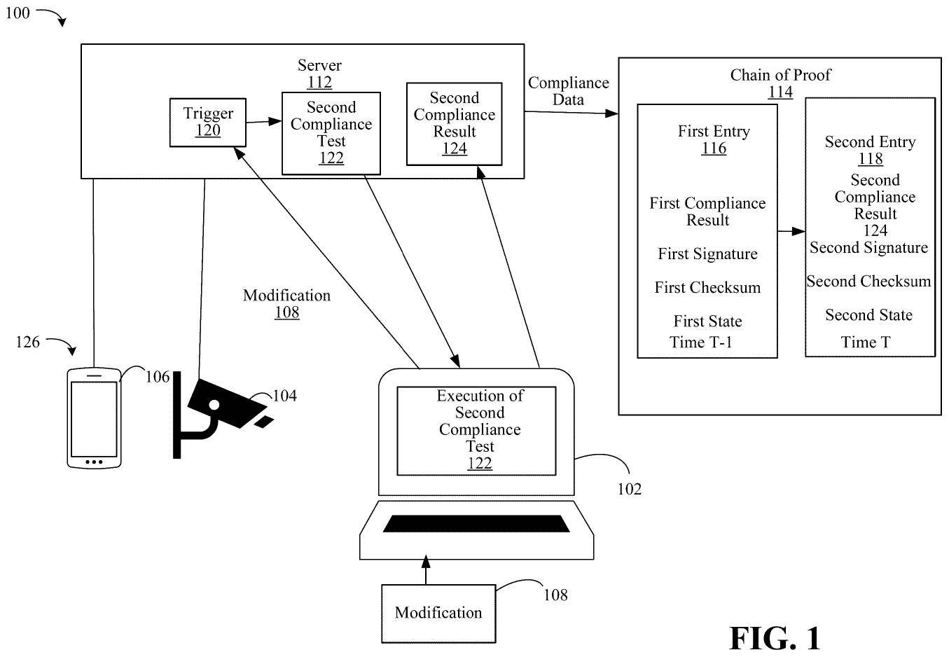

Turning now to FIG. 1, a granular compliance detection process 100 is illustrated. The granular compliance detection process 100 can be executed in a computer network with computing components and/or electronic components, and can be at least partially executed in software, hardware or both software and hardware.

In this example, a computing device 102 can be connected to a server 112 over a communication medium. Furthermore, a mobile device 106 and an internet of things (IoT) device 104 are also connected to the server 112. The computing device 102, IoT device 104, and mobile device 106 can constitute at least part of a computer network 126 (e.g., a business network). The computer network 126 can include more electronic devices (unillustrated). The server 112 can be responsible for identifying modifications to the computer network 126, determining whether those modifications affect compliance and recording such details (e.g., evidence) in a chain of proof 114 (e.g., chain of evidence).

The chain of proof 114 can be a shared immutable storage (e.g., blockchain). In some examples, the chain of proof 114 can be a storage (e.g., hard drive, solid state device, memory, etc.) that is configured to be read and write accessible by the server 112, and read only for any other component (e.g., computing device). Further examples for storage of the chain of proof 114 can also include cloud object storage (s3 type storage) and/or a document database. That is, the server 112 can be the only electronic device and/or computing device with the capability to modify and add entries into the chain of proof 114. In doing so, security can be enhanced by ensuring that the chain of proof 114 has not been tampered with, and that the evidence in chain of proof 114 is accurate. For example, each entry in the chain of proof 114 can have first checksum(s). That is, each entry of the chain of proof 114 can have one first checksum for each piece of evidence (e.g., each piece corresponding to one IT element such as a computing device, infrastructure, etc.) in a bundle of the entry.

Furthermore, the chain of proof 114 is stored in a central and secure location, which remedies the aforementioned difficulties in existing examples where evidence was stored in a multitude of locations. Storing the evidence in a secure, central location increases efficiency relative to existing examples, since the evidence is more accessible, trustworthy and accurate such that evidence need not be recreated and/or accidently lost.

The server 112 can identify that the computing device 102 (e.g., electronic device) is associated with the chain of proof 114. The chain of proof 114 includes a first entry 116. The first entry 116 is associated with a first compliance result of a first compliance test that was executed on the computing device 102 at a prior time.

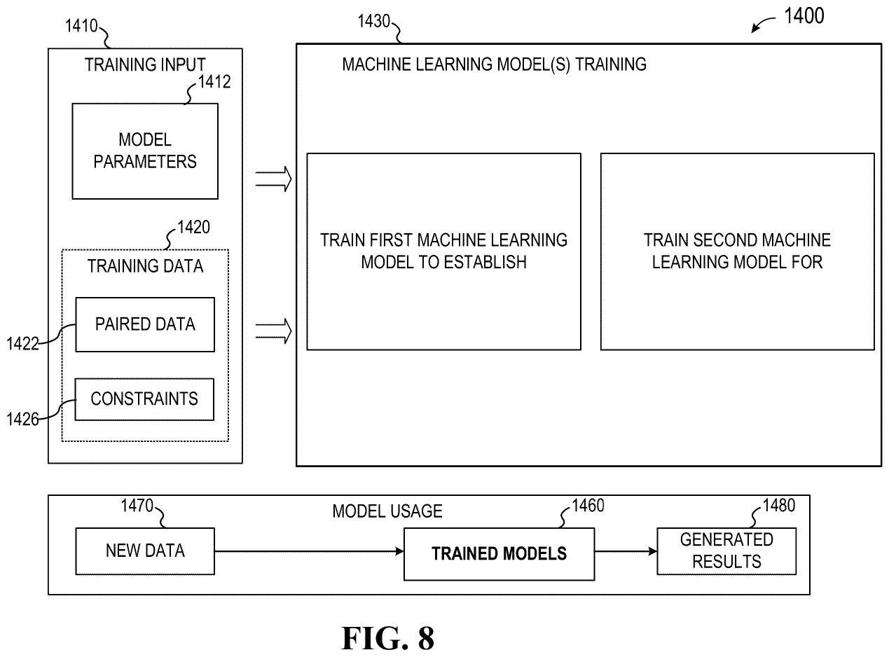

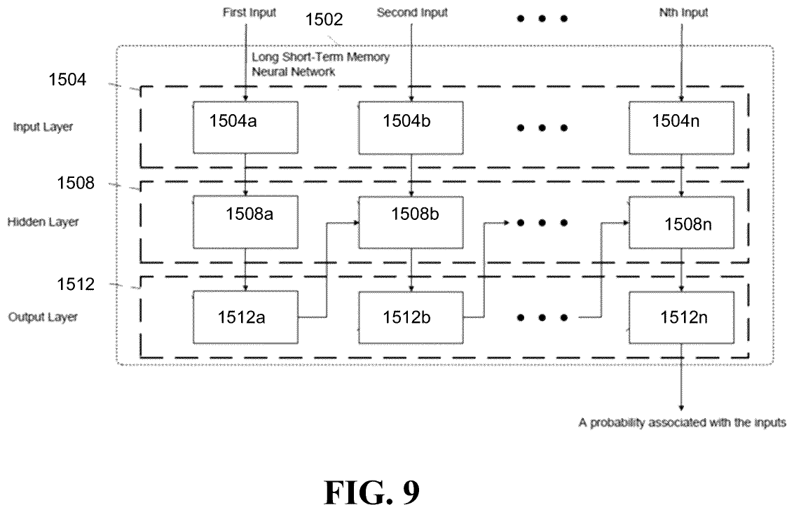

The first compliance result and/or first entry 116 is in a structured data format. The structured data format can be common to all entries of the chain of proof 114 to enable the server 112 to generate new entries with simple programs and analyze the entries to detect non-compliance and/or compliance. While machine learning models (e.g., using the systems described in FIGS. 8 and 9) can analyze the chain of proof 114, it will be appreciated that such machine learning models consume more processing power, energy and compute resources than a computer program (e.g., non-machine learning program) in which a programmer writes explicit rules or instructions for a computer to follow. Since the chain of proof 114 is in the structured data format, examples can analyze the chain of proof 114 with the computer program (a non-machine learning program that can be referred to as an “expert rule systems”) to reduce processing power, energy and compute resources relative to a machine learning model. The computer program does not rely on machine learning models but is explicitly programmed by a programmer. Furthermore, translating unstructured data that may originally be in computer readable formats (e.g., uncomprehensible to humans) into a structured data format readable and comprehensible by humans can facilitate human review to analyze in an internal/external audit situation.

That is, if the entries of the chain of proof 114 were in an unstructured data format, the server 112 would consume more computing resources to analyze the entries with a machine learning model to detect compliance and/or non-compliance, or would be unable to do so at all. Therefore, storing the entries of the chain of proof 114 in the structured data format enables less compute resources to be used for analysis, and permits less costly programs (e.g., smaller and less power intensive) analyze the entries.

The first entry 116 includes a first compliance result of a first compliance test. The first compliance result and test are associated with the computing device 102. For example, the first compliance test was executed on computing device 102 to determine the first compliance result. The first entry 116 also includes a first checksum that is evidence that the first compliance result is legitimately generated and unmodified (e.g., not tampered with). For example, the first checksum can be generated based characteristics of the first compliance result. Thus, if aspects of the first compliance result are changed, then the first checksum will no longer correspond to the first compliance result. That is, if another checksum is generated based on the changed first compliance result, the another checksum will fail to match the first checksum. The first checksum can also be generated based on unique characteristics of the computing device 102 when the first compliance test is executed, software of the computing device 102 when the first compliance test is executed, hardware of the computing device 102 when the first compliance test is executed, the first compliance test, the first compliance result, etc. The first checksum can be used to verify that the first entry 116 is unchanged. The first entry 116 also includes a first signature that can be a digital signature to ensure that the chain of proof 114 (e.g., bundle of evidence) was legitimately entered.

The first entry 116 further includes a first state. The first state is the state of the computing device 102 when the first compliance test is executed (e.g., software, hardware, a trigger and/or modification that caused the first compliance test to be executed, etc.). The first entry 116 further includes a time T−1 that indicates when the first compliance test was executed. Thus, the first entry 116 includes a record of aspects of the computing device 102 including compliance with security measures. In some examples, the first entry 116 can include data of all electronic devices and/or paths (e.g., connections, wires, etc.) of the computer network 126.

The server 112 can detect a modification 108 (e.g., a task and/or change event) is executed on the computing device 102. The server 112 can determine that the modification 108 is a trigger 120 that causes a reevaluation of compliance of the computer network 126. That is, the server 112 identifies a second compliance test 122 based on a detected change to the computing device 102 (e.g., electronic device). In some examples, a user can provide answers to a questionnaire relating to usage and data of the computing device 102 (e.g., whether sensitive data is being stored, programs, should the computing device 102 be HIPAA compliant, etc.), and the server 112 can identify the second compliance test 122 based on the answers and the modification 108. For example, if the modification 108 affects how data is accessed, then the second compliance test 122 can include verifying that a security protocol (e.g., cryptographic and/or encryption of data during transit) is enforced after the modification 108 is executed.

In some examples, the server 112 can automatically identify compliance tests such as second compliance test 122, based on factors identified from computer code of the computing device 102. For example, the server 112 can determine if the computing device 102 accesses certain sensitive data, if the computing device 102 executes a particular program associated with a heightened security risk, has a specific hardware, etc. In some examples, the server 112 can maintain a lookup table of programs, hardware and data and associated levels of security, as well as various compliance tests and/or compliance conditions for each of the programs, hardware and data. Based on the lookup table, the server 112 can determine which compliance tests are appropriate based on the data accessed by the computing device 102, hardware of the computing device 102 and software of the computing device 102.

As a consequence, the server 112 can determine that a second compliance test 122 is to be performed to determine whether the computer network 126 is compliant or non-compliant based on the modification 108. The modification 108 can be a software update, adjustment to settings, hardware changes, and/or any change to the controls and logic of the computing device 102.

Notably, in existing examples, the entire computer network 126 is analyzed for compliance. For example, the compliance tests (including the first compliance test) have already established that at time T−1, the computer network 126 was compliant. Therefore, the mobile device 106, IoT device 104 and computing device 102 were compliant at time T−1. Since the modification 108 only applies to the computing device 102, the server 112 identifies that only the computing device 102 is to be tested for compliance. Therefore, the IoT device 104 and mobile device 106 are bypassed for further testing. Doing so significantly reduces compute resources, storage, processing power and latency to execute the second compliance test 122.

Thus, the server 112 can provide a second compliance test 122 to the computing device 102. The computing device 102 can execute the second compliance test 122. In some examples, a human can be notified that the computing device 102 is to be evaluated for compliance due to the modification 108 and that the second compliance test 122 is to be executed to determine whether computing device 102 is compliant. The human can execute the second compliance test 122 and provide the second compliance result 124. If the computing device 102 meets the standards of the second compliance test, the computing device 102 passes the second compliance test. As noted above, the server 112 can execute the second compliance test 122.

For example, if the second compliance test 122 indicates that data at rest should be encrypted, and the computing device 102 encrypts data at rest, the computing device 102 can be deemed to pass the second compliance test. If the computing device 102 does not encrypt data at rest, then the computing device 102 can be deemed to not pass the second compliance test 122.

The indication of whether the computing device 102 passes or fails the second compliance result 124 can be provided to the server 112 as a second compliance result 124. In this example, the computing device 102 executes the second compliance test 122, determines the second compliance result 124 indicating whether the computing device 102 passes the second compliance test 122, and provides the second compliance result 124 to the server 112.

The server 112 can receive the second compliance result 124 of the second compliance test 122. The server 112 can modify the structure of the second compliance result 124 from an unstructured data format to the structured data format. In some examples, the second compliance result 124 can be provided from the computing device 102 in the structured data format.

In some examples, the server 112 can remotely execute the second compliance test 122. For example, the server 112 can analyze settings and logic of the computing device 102 to determine the second compliance result 124. Therefore, the computing device 102 and/or server 112 can execute the second compliance test to generate the second compliance result 124.

Some examples can enforce a “tree of trust” approach to compliance. In detail, examples can execute automatic verification of the tree of trust, meaning that a first electronic component is verified as being trustworthy (e.g., first trust level) by an already trustworthy source, and then elements (e.g., applications, programs, etc.) on the first electronic component can be verified by the first electronic component as being trustworthy, etc. In this example, the computing device 102 is verified as being trustworthy and is able to execute the second compliance test 122. If, however, suppose that the computing device 102 was not verified as being trustworthy, then another electronic component, such as the server 112, IoT device 104 and/or mobile device 106, can execute the second compliance test 122 on the computing device 102.

Compliance data, including the second compliance result 124 can be provided to the chain of proof 114 and recorded. That is, the second compliance result 124 is recorded into a second entry 118 of the chain of proof 114. Similar to the first entry 116, the second entry 118 includes a second checksum, second signature, second state and time T. Additionally, the second compliance result 124 is stored in the second entry 118.

The second checksum can be generated based on unique characteristics of the computing device 102 when the second compliance test is executed, software of the computing device 102 when the second compliance test 122 is executed, hardware of the computing device 102 when the second compliance test 122 is executed, the second compliance test 122, or the second compliance result 124. Similar to the first checksum, the second checksum can indicate whether an actor has tampered with the second compliance result 124. The second signature can be used to verify that an authorized electronic device and/or party executed the second compliance test 122, and can be a digital signature to ensure that the chain of proof 114 (e.g., bundle of evidence) was legitimately produced. The second entry 116 further includes a second state. The second state is the state of the computing device 102 when the second compliance test 122 is executed (e.g., software, hardware, a trigger and/or modification that caused the second compliance test 122 to be executed, etc.). The second entry 118 further includes a time T that indicates when the second compliance test 122 was executed. Thus, the second entry 118 includes a record of aspects of the computing device 102. In some examples, the second entry 118 can include data of all electronic devices and/or paths (e.g., connections, wires, etc.) of the computer network 126.

The server 112 and/or the chain of proof 114 can link the first and second entries 116, 118 in the chain of proof 114. In doing so, the entries of the chain of proof 114 can be arranged in order based on time, from least recent to most recent. For example, the first entry 116 can point to the second entry 118. If a third compliance test is executed on the computing device 102 at time T+1, a third compliance result of the third compliance test can be stored in the chain of proof 114. The second entry 118 can point to the third entry. The third entry can be in the structured data form and includes the third compliance result, third compliance test, third checksum, third signature, third state and time T+1, etc. Thus, the chain of proof 114 can include a record of all changes to the computing device 102 and whether the computing device 102 was compliant when the changes were instituted. In some examples, the chain of proof 114 can also point to other, related chains of proof based on interrelations between the chains. As one example, consider that the infrastructure (e.g., a computer and/or server) the chain of proof 114 is stored upon is interrelated to the chain of proof 114. That is, if the infrastructure is compromised, the chain of proof 114 cannot be trusted. Therefore, the chain of proof 114 can also point to a chain of proof for the infrastructure to ensure that the chain of proof 114 is trustworthy (e.g., not compromised). The chain of proof 114 can include any number of entries.

The nature of applications executing on the computing device 102, the modification 108 and/or hardware of the computing device 102 indicate which tests to execute at various times. So different rules can apply to different changes. The server 112 can record both the changes and rules to map the evolution of the computing device 102 and/or a program of the computing device 102, and when new rules (compliances) were applied. Examples of new rules (compliances) can include external change events such as a new client requiring a particular compliance (e.g., FEDRamp compliance), updates to National Institute of Standards & Technology (NIST) standards, additions to the devices business logic such as a new application and/or new code functionality, etc.

The server 112 can obtain a snapshot anytime there is a change and the rules that changed a version of the computing device 102. The snapshots are stored as a history of bundles of evidence, and the sets of rules that apply over time. Each of the snapshots can be a different entry, such as first entry 116 and second entry 118, of the chain of proof 114. Doing so exhibits compliance during an entire journey of an electronic component.

In some examples, if the mobile device 106 and/or IoT device 104 are updated, the process for example granular compliance detection process 100 can be executed on the mobile device 106 and/or the IoT device 104. The results can be stored in the chain of proof 114. In some examples, each individual electronic component of the computer network 126 has a distinct and different chain of proof to permit individual analysis of each component. For example, the granular compliance detection process 100 can be a distributed function, so that each respective piece verifies the evidence bundle (e.g., chain of proof) of the respective piece, and then the evidence bundles can be combined together. A piece means that each changed portion (e.g., infrastructure, application, in-ear monitor (IEM) policies, code pipeline modifications—pipeline infrastructure modifications, etc.) can verify the compliance of the piece, without all pieces reverifying all pieces.

In some examples, the server 112 can automatically adjust the computing device 102 if the second compliance result 124 indicates non-compliance to remedy the non-compliance. For example, if the compliance includes that the computing device 102 encrypt data at rest, and the computing device 102 does not do so, the server 112 can adjust the settings and configurations of the computing device 102 to automatically encrypt data at rest in order to pass the second compliance test 122. The second compliance result 124 can indicate that the computing device 102 passes the second compliance test 122 based on the adjustment.

In some examples, each control (e.g., electronic device, program on an electronic device, hardware, transmission path, etc.) has a unique identification that is associated with an evidence control bundle such as the chain of proof 114. The server 112 can associate sets of controls to control bundles by generating a hash table to relate the controls and the evidence control bundles. In doing so, compliance can be established or disproven for each individual control and at a granular level. Thus, numerous different chains of proof, similar to the chain of proof 114, can be generated for the controls. Furthermore, each IT component (e.g., electronic device, program on an electronic device, hardware, transmission path, etc.) can have an individual set of controls. Compliance can be determined for each control in a component's set and inform overall compliance for that component. Furthermore, components of the same type might have different sets based on business use case and risk tolerance.

Furthermore, while modification 108 was described above as triggering an analysis of compliance of the computing device 102, it will be understood that various other triggers can cause compliance analysis. For example, the addition of a new electronic device (e.g., a new server, router, mobile device, etc.) can trigger a compliancy analysis of the new electronic device. In such an example, a different electronic device can execute the compliancy analysis of the new electronic device to verify that the new electronic device can be trusted (e.g., added to the tree of trust). Thereafter, the new electronic device can execute compliance analysis on various software and hardware of the new electronic device.

It is to be noted that any and/or all of the electronic components of computer network 126, server 112 and/or chain of proof 114 can be implemented in in logic instructions (e.g., software), configurable logic, fixed-functionality hardware logic, computer readable instructions stored on at least one non-transitory computer readable storage medium that are executable to implement process 100, circuitry, etc., or any combination thereof.

It is worth noting that any and/or all of the electronic components of computer network 126, server 112 and/or chain of proof 114 can communicate over a network(s). The network(s) can include, or operate in conjunction with, an ad hoc network, an intranet, an extranet, a virtual private network (VPN), a local area network (LAN), a wireless network, a low energy Bluetooth (BLE) connection, a WiFi direct connection, a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network can include a wireless or cellular network and the coupling can be a Code Division Multiple Access (CDMA) connection, a Global System for Mobile communications (GSM) connection, or other type of cellular or wireless coupling. In this example, the coupling can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

Some examples of sensitive data (which trigger security compliance) include personal information also known as personally identifiable information (PII) (e.g., names, addresses, phone numbers, social security numbers, and driver's license numbers). Other examples of sensitive data include financial information (e.g., credit card numbers, bank account information, outstanding debt, financial assets, etc.) Other examples of sensitive data include medical information (e.g., health-related data, insurance numbers, policy numbers, claims, etc.). Other examples of sensitive data include genetic data (e.g., biometric data used to identify an individual). Other examples of sensitive data include confidential information (e.g., information that could be used to identify or track an individual, such as criminal records). Other examples of sensitive data include data that reveals racial or ethnic origin. Other examples of sensitive data include political opinions, religious or philosophical beliefs, trade-union membership, data pertaining to a person's sex life or sexual orientation.

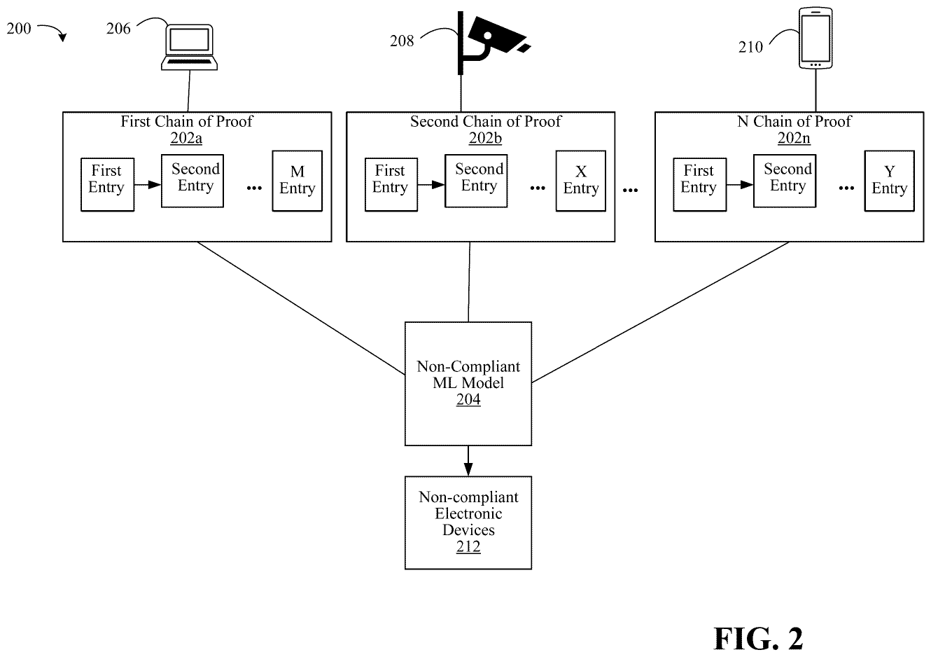

Turning now to FIG. 2, a process 200 to detect non-compliance is illustrated. The process 200 can generally be implemented in conjunction with any of the examples described herein for example the granular compliance detection process 100 (FIG. 1).

In this example, a non-compliant machine learning (ML) model 204 (e.g., using the systems described in FIGS. 8 and 9 which includes artificial intelligence models) is trained to detect characteristics of non-compliance. That is, the process 200 trains a machine learning model (e.g., using the systems described in FIGS. 8 and 9) to analyze chain of proofs to detect non-compliance.

In this example, electronic devices include a computing device 206, an IoT device 208 (e.g., camera) and a mobile device 210 which form a computer network. Each of the computing device 206, IoT device 208 and mobile device 210 are associated with a different chain of proof. For example, the computing device 206 is associated with a first chain of proof 202a, the IoT device 208 is associated with a second chain of proof 202b and the mobile device 210 is associated with an N chain of proof 202n. Notably, any number of electronic devices can be included that are associate with a different chain of proof of the first-N chain of proofs 202a-202n. Each of the first-N chain of proofs 202a-202n includes a different amount of entries corresponding to different changes of associated electronic devices.

In this example, the non-compliant ML model 204 analyzes the first-N chain of proofs 202a-202n to detect non-compliance. For example, the non-compliant ML model 204 can examine characteristics of the first-N chain of proofs 202a-202n and the entries to detect non-compliance. In such an example, the first-N chains of proof 202a-202n can be in different and unstructured data formats. As a result, the non-compliant electronic devices 212 can be identified and output in real time.

In detail, examples can gather training data (e.g., from human audits who mark complaint and non-compliant data for a given control). A ML model (e.g., using the systems described in FIGS. 8 and 9) can be trained on such a data set. The ML model can recognize outliers in the first-N chains of proof 202a-202n (e.g., stored in storage systems) and flag the outliers for follow up by a human and/or automated process. The flag can be a simple design, such as a minimal or empty documents and pattern outliers for a given control.

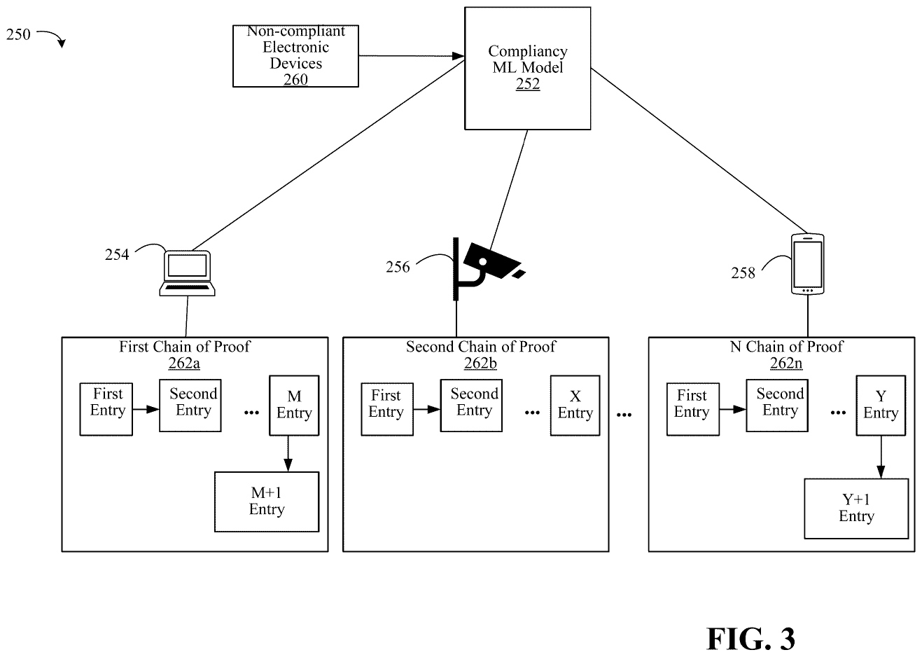

Turning now to FIG. 3, a process 250 to remedy non-compliance is illustrated. The process 250 can generally be implemented in conjunction with any of the examples described herein for example the granular compliance detection process 100 (FIG. 1) and/or process 200 (FIG. 2).

In this example, the compliancy ML model 252 (e.g., using the systems described in FIGS. 8 and 9) is trained to remedy instances of non-compliance. The ML model 252 can receive the non-compliant electronic devices 260 (e.g., a list of non-compliant devices and which tests the non-compliant devices failed). The non-compliant ML model 204 (FIG. 2) can generate the non-compliant electronic devices 260.

The compliancy ML model 252 is trained to remedy non-compliance and automatically enforce compliancy with certain security measures. In this example, the compliancy ML model 252 adjusts characteristics of electronic devices, for example computing device 254, IoT device 256 and mobile device 258. The computing device 254, IoT device 256 and mobile device 258 are associated with first chain of proof 262a, second chain of proof 262b and N chain of proof 262n respectively.

For example, if the computing device 254 does not meet HIPAA standards, the computing device 254 can be adjusted until the computing device 254 meets the HIPPA standards. If the IoT device 256 fails to meet certain privacy requirements, the IoT device 256 can be adjusted until the IoT device 256 meets the privacy requirements (e.g., encrypt video feed).

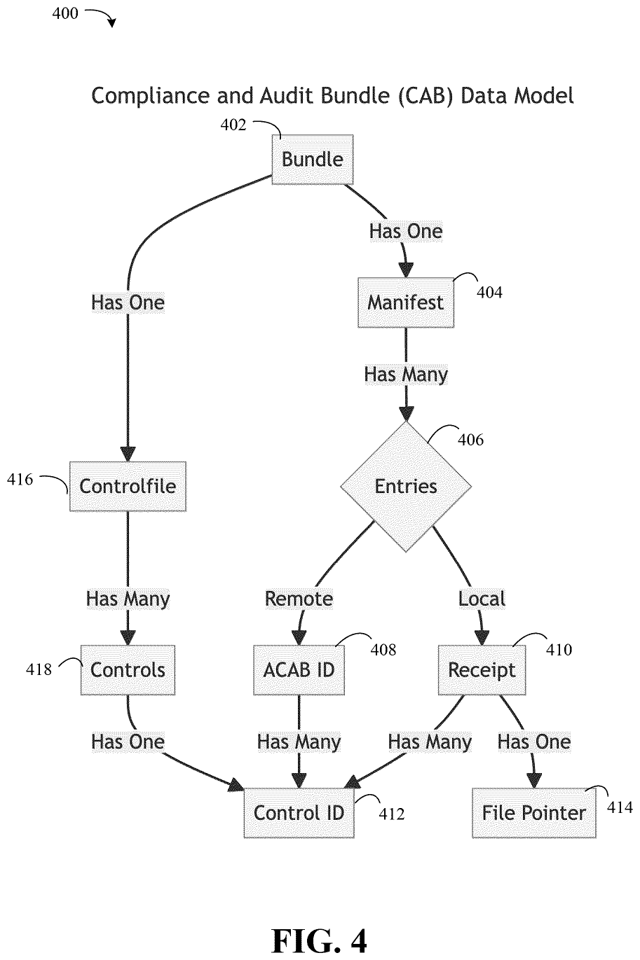

FIG. 4 illustrates a compliance and audit bundle (CAB) data model 400. The CAB data model 400 can generally be implemented in conjunction with any of the examples described herein for example the granular compliance detection process 100 (FIG. 1), process 200 (FIG. 2) and/or process 250 (FIG. 3). A bundle 402 is provided. The bundle 402 can be a collection of evidence of compliance. The bundle 402 has several manifests 404. A manifest 404 is a summary document of each piece of evidence submitted and which control(s) the piece of evidence satisfies. The manifest 404 has many entries 406. The entries 406 include remote ACAB IDs 408 and local receipts 410. The ACAB can be an “archived compliance and audit bundle” with the remove ACAB IDs 408 each being reference to another and related chain (e.g., related IT components) of proof bundle.

The remote ACAB ID 408 and receipts 410 have many control IDs 412. The control IDs 412 can be compliance based IDs. The receipt 410 has one file pointer 414. The bundle has one control file 416. The control file 416 includes many controls 418. The controls 418 include one control ID 412. A control can be safeguards and countermeasures used to reduce risk, and control IDs 412 can each be a unique identification for the control (e.g., NIST 500 ID). A control file can be a point in time record of in-scope controls applicable to a given activity.

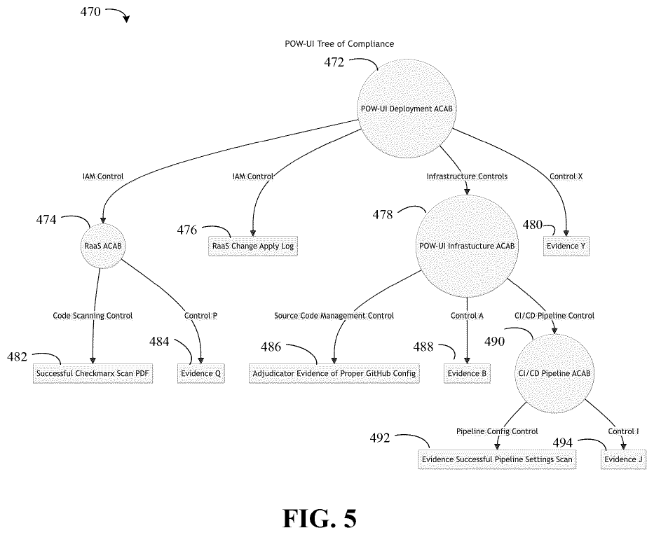

FIG. 5 illustrates a proof-of-work user-interface (POW-UI) tree of compliance 470. The POW-UI tree of compliance 470 can generally be implemented in conjunction with any of the examples described herein, for example granular compliance detection process 100 (FIG. 1), process 200 (FIG. 2), process 250 (FIG. 3) and/or data model 400 (FIG. 4).

The POW-UI tree of compliance 472 includes a POW-UI tree of deployment ACAB. The POW-UI tree of compliance 472 includes an IAM control for a Roles as a Service (RaaS) ACAB 474. POW-UI tree of compliance 472 includes an IAM control for RaaS change apply log 476. POW-UI tree of compliance 472 includes an infrastructure control that includes a POW-UI infrastructure ACAB. POW-UI tree of compliance 472 includes a control X that includes Evidence Y 480.

The RaaS ACAB 474 includes a code scanning control for successful checksum scan PDF 482, and a control P for evidence Q 484. The POW-UI infrastructure ACAB 478 includes a source code management control for an adjudicator of evidence of proper GitHub configuration 486, a control A for evidence B 488 and a CI/CD pipeline control for CI/CD pipeline ACAB 490. The CI/CD pipeline ACAB 490 includes a pipeline configuration control for evidence successful pipeline settings scan 492 and an evidence J 494.

A POW-IU can include a web application. A POW-UI tree of compliance 472 can include an Archived Compliance and Audit Bundle (ACAB) generated during a deployment activity and/or event. The RaaS ACAB 474 includes an evidence to satisfy an example IAM control (Identity and Access management) and can be another Archived Compliance and Audit Bundle (ACAB) generated by the version of the Roles as a Service (RaaS) tool that POW-UI Deployment ACAB of POW-UI tree of compliance 472 utilizes. The RaaS ACAB 474 can contain two pieces of evidence: successful checksum scan PDF 482 (e.g., satisfies an example code scanning control), and example evidence Q 484 (e.g., satisfies example control P (showing n controls+evidence). RaaS change apply log 476 references a change that the RaaS made on behalf of the POW-UI application. The CI/CD (continuous integration, continuous deployment) pipeline ACAPB 490 includes a continuous integration, continuous deployment architecture.

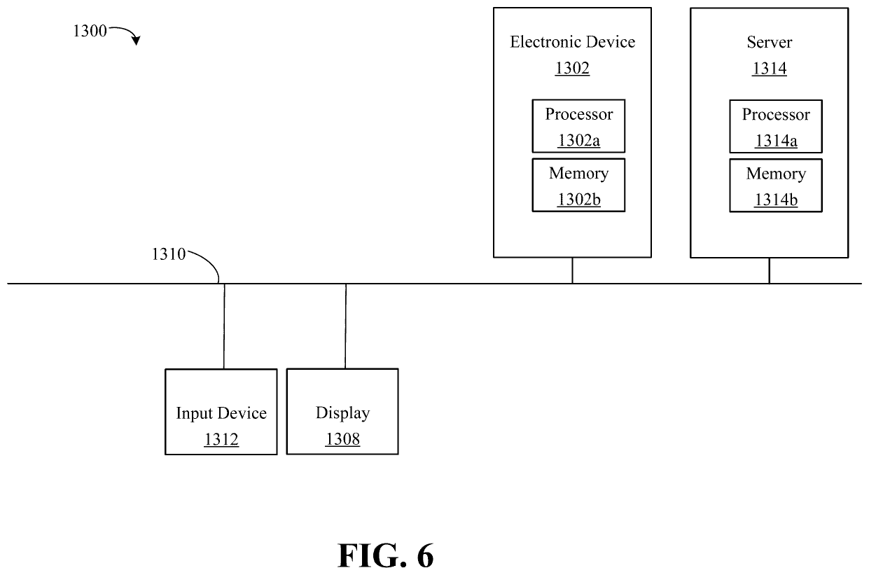

FIG. 6 shows a more detailed example of a computing architecture 1300 to execute a compliance process. The computing architecture 1300 can generally be implemented in conjunction with any of the examples described herein, for example granular compliance detection process 100 (FIG. 1), process 200 (FIG. 2), process 250 (FIG. 3), data model 400 (FIG. 4) and/or POW-UI tree of compliance 470 (FIG. 5).

In the illustrated example, the computing architecture 1300 can include a network 1310 that can facilitate communication between server 1314, electronic device 1302 (e.g., part of a network), input device 1312, and display 1308. The display 1308 (e.g., audio and/or visual interface) can present compliance notifications to a user, and the input device 1312 can receive user inputs (e.g., compliance test initiation, compliance testing, etc.).

The server 1314 includes a processor 1314a (e.g., embedded controller, central processing unit/CPU) and a memory 1314b (e.g., non-volatile memory/NVM and/or volatile memory) containing a set of instructions, which when executed by the processor 1314a, cause the server 1314 to implement aspects described herein. For example, the processor 1314a can identify that the electronic device 1302 is associated with a chain of proof that includes a first entry, where the first entry is associated with a first compliance result of a first compliance test that is executed on the electronic device, where the first compliance result is in a structured data format. The processor 1314a can identify a trigger to execute a second compliance test for the electronic device 1302, identify a second compliance result of the second compliance test, where the second compliance result is in the structured data format, and record the second compliance result into a second entry of the chain of proof.

The electronic device 1302 includes a processor 1302a (e.g., embedded controller, central processing unit/CPU) and a memory 1302b (e.g., non-volatile memory/NVM and/or volatile memory) containing a set of instructions, which when executed by the processor 1302a, cause the electronic device 1302 to implement aspects described herein, for example executing a compliance test and/or notifying the server 1314 of a modification to the electronic device 1302.

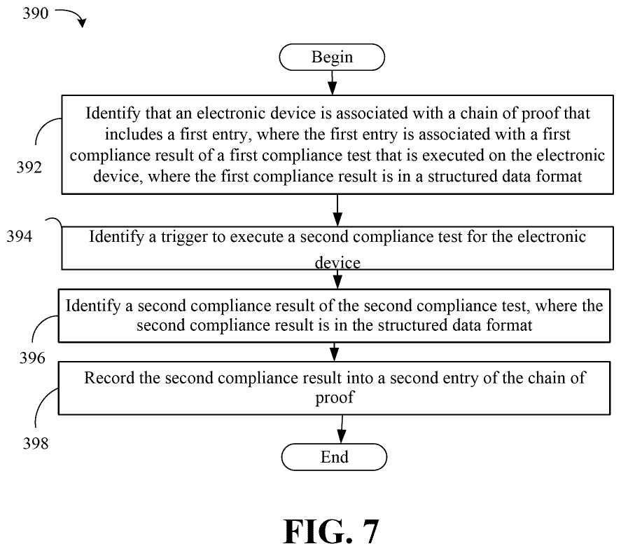

FIG. 7 illustrates a method 390 of establishing baseline measurements of a user. The method 390 can be implemented in conjunction with any of the examples described herein, The method 390 can generally be implemented in conjunction with any of the examples described herein, for example granular compliance detection process 100 (FIG. 1), process 200 (FIG. 2), process 250 (FIG. 3), data model 400 (FIG. 4) and/or POW-UI tree of compliance 470 (FIG. 5) and/or computing architecture 1300 (FIG. 6).

Illustrated processing block 392 identifies that an electronic device is associated with a chain of proof that includes a first entry, where the first entry is associated with a first compliance result of a first compliance test that is executed on the electronic device, where the first compliance result is in a structured data format. Illustrated processing block 394 identifies a trigger to execute a second compliance test for the electronic device. Illustrated processing block 396 identifies a second compliance result of the second compliance test, wherein the second compliance result is in the structured data format. Illustrated processing block 398 records the second compliance result into a second entry of the chain of proof.

In some examples, the method 390 includes identifying the second compliance test based on a detected change to the electronic device. In some examples, the method 390 includes executing the second compliance test to generate the second compliance result. In some examples, the method 390 includes analyzing the chain of proof to detect non-compliance with an expert rule system. In some examples, when the second compliance result indicates non-compliance, the method 390 includes remedying the non-compliance by automatically adjusting the electronic device. In some examples, the method 390 includes generating a checksum based on one or more of the electronic device, the second compliance result or the second compliance test, generating a signature, and storing the signature and the checksum into the second entry, and linking the first and second entries in the chain of proof. In some examples, the trigger is one or more of a software modification to the electronic device or a hardware modification to the electronic device.

Example systems and methods for automated security and compliance analysis in a computerized framework herein. In some examples, the computing systems relate to healthcare in which providers are healthcare providers and consumers are patients, although not all examples of the inventive subject matter are limited to healthcare services. In such examples, maintaining secure and robust computer architectures enables the provisioning of services at scale. Some examples may be used in connection with other types of services and/or industries, such as legal counseling, financial advisement services, retail sales, computer troubleshooting, computer engineering, or the like. Users of computer architectures may interact with each other via online communications, emails, data storage, videoconferences, teleconferences channels (e.g., using electronic communication devices connected over a communication network or channel). Users may access the computer architectures via an electronic communication device such as a mobile phone, tablet computer, laptop computer, desktop computer, smart television, or the like.

FIG. 8 is a block diagram of an example service of a machine learning model 1400 that may be deployed within granular compliance detection process 100 (FIG. 1), process 200 (FIG. 2), process 250 (FIG. 3), data model 400 (FIG. 4), POW-UI tree of compliance 470 (FIG. 5), computing architecture 1300 (FIG. 6) and/or method 390 (FIG. 7), according to some examples. Training input 1410 includes model parameters 1412 and training data 1420, which may include paired training data sets 1422 (e.g., input-output training pairs) and constraints 1426. Model parameters 1412 store or provide the parameters or coefficients of corresponding ones of machine learning models. During training, these parameters 1412 are adapted based on the input-output training pairs of the training data sets 1422. After the model parameters 1412 are adapted (after training), the model parameters 1412 are used by trained models 1460 to implement the trained machine learning models on a new set of data 1470 (e.g., for auditing).

Training data 1420 includes constraints 1426 which may define the constraints of a given patient information features. The paired training data sets 1422 may include sets of input-output pairs, such as pairs of a plurality of training compliance bundle features and features of compliance documents that are created in association with one or more of the training data (e.g., ground-truth non-compliance and compliance). Some components of training input 1410 may be stored separately at a different off-site facility or facilities than other components.

Machine learning model(s) training 1430 trains one or more machine learning techniques based on the sets of input-output pairs of paired training data sets 1422. For example, the model training 1430 may train the machine learning (ML) model parameters 1412 by minimizing a loss function based on one or more ground-truth patient encounter documents generated in association with a training transcription. The ML model can include any one or combination of classifiers or neural networks, such as an artificial neural network, a convolutional neural network, an adversarial network, a generative adversarial network, a deep feed forward network, a radial basis network, a recurrent neural network, a long/short term memory network, a gated recurrent unit, an auto encoder, a variational autoencoder, a denoising autoencoder, a sparse autoencoder, a Markov chain, a Hopfield network, a Boltzmann machine, a restricted Boltzmann machine, a deep belief network, a deep convolutional network, a deconvolutional network, a deep convolutional inverse graphics network, a liquid state machine, an extreme learning machine, an echo state network, a deep residual network, a Kohonen network, a support vector machine, a neural Turing machine, an LLM, a generative network, a diffusion model, and the like.

Particularly, the ML model can be applied to a training batch of audit and compliance features to estimate or generate one or more preliminary compliance documents, compliance documents, non-compliance documents and/or security documents. In some implementations, a derivative of a loss function is computed based on a comparison of the one or more preliminary compliance documents, compliance documents, non-compliance documents and/or security documents and the ground truth compliance, compliance, non-compliance and/or security documents associated with the training batch of audit and compliance features and parameters of the ML model are updated based on the computed derivative of the loss function.

The result of minimizing the loss function for multiple sets of training data trains, adapts, or optimizes the model parameters 1412 of the corresponding ML models. In this way, the ML model is trained to establish a relationship between a plurality of training features and ground-truth compliance and/or security outcomes (e.g., compliance results).

After the machine learning model is trained, new data 1470, including one or more preliminary compliance documents and/or security documents are received and/or derived. The trained machine learning model may be applied to the new data 1470 to generate results 1480 including a compliance result, compliance decision, and/or non-compliance decision. The compliance data (e.g., compliance result, compliance bundle, compliance decision, non-compliance decision0 can be represented in a GUI, such as in a prompt overlaid on the GUI allowing a security technician to selectively remediate and/or analyze security flaws.

FIG. 9 is a functional block diagram of an example neural network 1502 that can be used for the inference engine or other functions (e.g., engines) as described herein to produce a machine learning model to determine compliance. The neural network 1502 can be included as part of granular compliance detection process 100 (FIG. 1), process 200 (FIG. 2), process 250 (FIG. 3), data model 400 (FIG. 4), POW-UI tree of compliance 470 (FIG. 5), computing architecture 1300 (FIG. 6) and/or method 390 (FIG. 7), according to some examples. The machine learning model can identify or generate compliance results, non-compliance and compliance decisions, and/or obtain information related to compliance. In an example, the neural network 1502 can be a LSTM neural network. In an example, the neural network 1502 can be a recurrent neural network (RNN). The example neural network 1502 may be used to implement the machine learning as described herein, and various implementations may use other types of machine learning networks. The neural network 1502 includes an input layer 1504, a hidden layer 1508, and an output layer 1512. The input layer 1504 includes inputs 1504a, 1504b . . . 1504n. The hidden layer 1508 includes neurons 1508a, 1508b . . . 1508n. The output layer 1512 includes outputs 1512a, 1512b . . . 1512n.

Each neuron of the hidden layer 1508 receives an input from the input layer 1504 and outputs a value to the corresponding output in the output layer 1512. For example, the neuron 1508a receives an input from the input 1504a and outputs a value to the output 1512a. Each neuron, other than the neuron 1508a, also receives an output of a previous neuron as an input. For example, the neuron 1508b receives inputs from the input 1504b and the output 1512a. In this way the output of each neuron is fed forward to the next neuron in the hidden layer 1508. The last output 1512n in the output layer 1512 outputs a probability associated with the inputs 1504a-1504n. Although the input layer 1504, the hidden layer 1508, and the output layer 1512 are depicted as each including three elements, each layer may contain any number of elements. Neurons can include one or more adjustable parameters, weights, rules, criteria, or the like.

In various implementations, each layer of the neural network 1502 must include the same number of elements as each of the other layers of the neural network 1502. For example, training GUI features (e.g., fields of a GUI presented to an operator) may be processed to create the inputs 1504a-1504n. The neural network 1502 may implement a model to produce one or more preliminary compliance results in association with the compliance features. More specifically, the inputs 1504a-1504n can include fields of the compliance features (binary, vectors, factors or the like) stored in the storage device. The fields of the compliance features can be data features that are be provided to neurons 1508a-1508n for analysis and connections between the known facts. The neurons 1508a-1508n, upon finding connections, provides the potential connections as outputs to the output layer 1512, which determines a compliance result, compliance, non-compliance, etc.

The neural network 1502 can perform any of the above calculations. The output of the neural network 1502 can be used to trigger display of a prompt that includes the compliance result document in a GUI. For example, the prompt (e.g., notification) can be provided to an auditor, security analyst, programmer, etc.

In some examples, a convolutional neural network may be implemented. Similar to neural networks, convolutional neural networks include an input layer, a hidden layer, and an output layer. However, in a convolutional neural network, the output layer includes one fewer output than the number of neurons in the hidden layer and each neuron is connected to each output. Additionally, each input in the input layer is connected to each neuron in the hidden layer. In other words, input 1504a is connected to each of neurons 1508a, 1508b . . . 1508n.

The present systems and methods (e.g., ML models) can identify that an electronic device is associated with a chain of proof that includes a first entry, where the first entry is associated with a first compliance result of a first compliance test that is executed on the electronic device, where the first compliance result is in a structured data format. Examples can further identify a trigger to execute a second compliance test for the electronic device, identify a second compliance result of the second compliance test, wherein the second compliance result is in the structured data format and record the second compliance result into a second entry of the chain of proof. Examples can also analyze the first and second compliance results to determine compliance or non-compliance, as well as security risks. Some examples can generate an automatic remediation process to address and correct any non-compliance that is identified, so that the non-compliance is eliminated (e.g., the electronic device becomes compliant).

“COMPONENT” in this context refers to a device, physical entity, or logic having boundaries defined by function or subroutine calls, branch points, APIs, or other technologies that provide for the partitioning or modularization of particular processing or control functions. Components can be combined via their interfaces with other components to carry out a machine process. A component can be a packaged functional hardware unit designed for use with other components and a part of a program that usually performs a particular function of related functions. Components can constitute either software components (e.g., code embodied on a machine-readable medium) or hardware components. A “hardware component” is a tangible unit capable of performing certain operations and can be configured or arranged in a certain physical manner. In various examples, one or more computer systems (e.g., a standalone computer system, a client computer system, or a server computer system) or one or more hardware components of a computer system (e.g., a processor or a group of processors) can be configured by software (e.g., an application or application portion) as a hardware component that operates to perform certain operations as described herein.

A hardware component can also be implemented mechanically, electronically, or any suitable combination thereof. For example, a hardware component can include dedicated circuitry or logic that is permanently configured to perform certain operations. A hardware component can be a special-purpose processor, such as a Field-Programmable Gate Array (FPGA) or an ASIC. A hardware component can also include programmable logic or circuitry that is temporarily configured by software to perform certain operations. For example, a hardware component can include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) can be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor can be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components can be regarded as being communicatively coupled. Where multiple hardware components exist contemporaneously, communications can be achieved through signal transmission (e.g., over appropriate circuits and buses) between or among two or more of the hardware components. In examples in which multiple hardware components are configured or instantiated at different times, communications between such hardware components can be achieved, for example, through the storage and retrieval of information in memory structures to which the multiple hardware components have access. For example, one hardware component can perform an operation and store the output of that operation in a memory device to which it is communicatively coupled. A further hardware component can then, at a later time, access the memory device to retrieve and process the stored output.

Hardware components can also initiate communications with input or output devices and can operate on a resource (e.g., a collection of information). The various operations of example methods described herein can be performed, at least partially, by one or more processors that are temporarily configured (e.g., by software) or permanently configured to perform the relevant operations. Whether temporarily or permanently configured, such processors can constitute processor-implemented components that operate to perform one or more operations or functions described herein. As used herein, “processor-implemented component” refers to a hardware component implemented using one or more processors. Similarly, the methods described herein can be at least partially processor-implemented, with a particular processor or processors being an example of hardware. For example, at least some of the operations of a method can be performed by one or more processors or processor-implemented components. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API). The performance of certain of the operations can be distributed among the processors, not only residing within a single machine, but deployed across a number of machines. In some example examples, the processors or processor-implemented components can be located in a single geographic location (e.g., within a home environment, an office environment, or a server farm). In other example examples, the processors or processor-implemented components can be distributed across a number of geographic locations.

The term “coupled” can be used herein to refer to any type of relationship, direct or indirect, between the components in question, and can apply to electrical, mechanical, fluid, optical, electromagnetic, electromechanical or other connections. In addition, the terms “first”, “second”, etc. can be used herein only to facilitate discussion, and carry no particular temporal or chronological significance unless otherwise indicated.

Those skilled in the art will appreciate from the foregoing description that the broad techniques of the examples of the present disclosure can be implemented in a variety of forms. Therefore, while the examples of this disclosure have been described in connection with particular examples thereof, the true scope of the examples of the disclosure should not be so limited since other modifications will become apparent to the skilled practitioner upon a study of the drawings, specification, and following claims.

We claim:

1. A computing system comprising:
a processor; and
a memory having a set of instructions, which when executed by the processor, cause the computing system to:
identify that an electronic device is associated with a chain of proof that includes a first entry, wherein the first entry is associated with a first compliance result of a first compliance test that is executed on the electronic device, wherein the first compliance result is in a structured data format;
identify a trigger to execute a second compliance test for the electronic device;
identify a second compliance result of the second compliance test, wherein the second compliance result is in the structured data format; and
record the second compliance result into a second entry of the chain of proof.

2. The computing system of claim 1, wherein:
identify the second compliance test based on a detected change to the electronic device.

3. The computing system of claim 1, wherein the instructions of the memory, when executed, cause the computing system to:
execute the second compliance test to generate the second compliance result; and
analyze the chain of proof to detect non-compliance with a machine learning model.

4. The computing system of claim 1, wherein the instructions of the memory, when executed, cause the computing system to:
analyze the chain of proof to detect non-compliance with an expert rule system.

5. The computing system of claim 1, wherein the instructions of the memory, when executed, cause the computing system to:
when the second compliance result indicates non-compliance, remedy the non-compliance by automatically adjusting the electronic device.

6. The computing system of claim 1, wherein the instructions of the memory, when executed, cause the computing system to:
generate a checksum based on one or more of the electronic device, the second compliance result or the second compliance test;
generate a signature; and
store the signature and the checksum into the second entry.

7. The computing system of claim 1, wherein:
the trigger is one or more of a software modification to the electronic device or a hardware modification to the electronic device; and
the instructions of the memory, when executed, cause the computing system to link the first and second entries in the chain of proof.

8. At least one non-transitory computer readable storage medium comprising a set of instructions, which when executed by a computing system, cause the computing system to:
identify that an electronic device is associated with a chain of proof that includes a first entry, wherein the first entry is associated with a first compliance result of a first compliance test that is executed on the electronic device, wherein the first compliance result is in a structured data format;
identify a trigger to execute a second compliance test for the electronic device;
identify a second compliance result of the second compliance test, wherein the second compliance result is in the structured data format; and
record the second compliance result into a second entry of the chain of proof.

9. The at least one non-transitory computer readable storage medium of claim 8, wherein the instructions, when executed, cause the computing system to:
identify the second compliance test based on a detected change to the electronic device.

10. The at least one non-transitory computer readable storage medium of claim 8, wherein the instructions, when executed, cause the computing system to:
execute the second compliance test to generate the second compliance result; and
analyze the chain of proof to detect non-compliance with a machine learning model.

11. The at least one non-transitory computer readable storage medium of claim 8, wherein the instructions, when executed, cause the computing system to:
analyze the chain of proof to detect non-compliance with an expert rule system.

12. The at least one non-transitory computer readable storage medium of claim 8, wherein the instructions, when executed, cause the computing system to:
when the second compliance result indicates non-compliance, remedy the non-compliance by automatically adjusting the electronic device.

13. The at least one non-transitory computer readable storage medium of claim 8, wherein the instructions, when executed, cause the computing system to:
generate a checksum based on one or more of the electronic device, the second compliance result or the second compliance test;
generate a signature; and
store the signature and the checksum into the second entry.

14. The at least one non-transitory computer readable storage medium of claim 8, wherein:
the trigger is one or more of a software modification to the electronic device or a hardware modification to the electronic device; and
the instructions, when executed, cause the computing system to link the first and second entries in the chain of proof.

15. A method comprising:
identifying that an electronic device is associated with a chain of proof that includes a first entry, wherein the first entry is associated with a first compliance result of a first compliance test that is executed on the electronic device, wherein the first compliance result is in a structured data format;
identifying a trigger to execute a second compliance test for the electronic device;
identifying a second compliance result of the second compliance test, wherein the second compliance result is in the structured data format; and
recording the second compliance result into a second entry of the chain of proof.

16. The method of claim 15, comprising:
identifying the second compliance test based on a detected change to the electronic device.

17. The method of claim 15, comprising:
executing the second compliance test to generate the second compliance result; and
analyzing the chain of proof to detect non-compliance with a machine learning model.

18. The method of claim 15, comprising:
analyzing the chain of proof to detect non-compliance with an expert rule system.

19. The method of claim 15, comprising:
when the second compliance result indicates non-compliance, remedying the non-compliance by automatically adjusting the electronic device.

20. The method of claim 15, comprising:
generating a checksum based on one or more of the electronic device, the second compliance result or the second compliance test;
generating a signature; and
storing the signature and the checksum into the second entry;
linking the first and second entries in the chain of proof,
wherein the trigger is one or more of a software modification to the electronic device or a hardware modification to the electronic device.
